(19) United States
(12) Patent Application Publication
(10) Pub. No.: US 2016/0185963 A1
(43) Pub. Date: Jun. 30, 2016

(54) COMPOSITE RESIN COMPOSITION HAVING ENHANCED PLATING ADHESION

(71) Applicant: Hyundai Motor Company, Seoul (KR)

(72) Inventor: Jae Sik Seo, Suwon (KR)

(21) Appl. No.: 14/967,324

(22) Filed: Dec. 13, 2015

(30) Foreign Application Priority Data
Dec. 31, 2014 (KR) 10-2014-0195117

(51) Int. Cl. C08L 77/06; C23C 30/00

(52) U.S. Cl. CPC C08L 77/06; C23C 30/00

(57) ABSTRACT

The present invention relates to a composite resin composition that comprises a polyphthalamide, an impact modifier and an inorganic filler, thereby providing substantially improved plating adhesion. When the composite resin composition is used as a molded product of a plated product, an occurrence of cracks on a plating layer can be prevented due to substantially improved rigidity and deformation can be minimized despite repetitive operation, and stripping of the plating layer can be prevented due to improved plating adhesion.

### CROSS-REFERENCE TO RELATED APPLICATION

This application claims under 35 U.S.C. §119(a) the benefit of Korean Patent Application No. 10-2014-0195117 filed on Dec. 31, 2014, the entire contents of which are incorporated herein by reference.

### TECHNICAL FIELD

The present invention relates to a composite resin and its composition to provide improved plating adhesion. When the composite resin is used as a molded product of a plated product, an occurrence of cracks on a plating layer may be prevented due to substantially improved rigidity, deformation may be minimized despite repetitive operation, and stripping of the plating layer may be prevented due to substantially improved plating adhesion to the molded product.

### BACKGROUND

Plated products can be prepared by surface treatment such as plating/painting on a molded product of a plastic material so as to have an appearance of a metal texture and the like. An important physical property in plated products may be adhesion between a molded product and a plating layer, for example, plating layer may strip due to reduced adhesion. Further, rigidity of a molded product may also be an important factor, for example, when a molded product has insufficient rigidity, deformation between operations of the molded product may occur significantly thereby causing the occurrence of plating layer cracks and stripping.

One example of plated products may include an interior side door handle of a vehicle. A door handle typically experiences repetitive hand contact when a passenger inside a vehicle goes outside, therefore, when adhesion between a molded product and a plating layer is weak, the plating layer may be stripped, and when the molded product has low rigidity, handle deformation may occur thereby causing cracks in the plating layer, and then leading to stripping. Accordingly, there may be a serious problem in safety in that a passenger may be injured in the hand and the like.

In the related arts, a PC/ABS resin blending an acrylonitrile-butadiene-styrene (ABS) resin and polycarbonate has been used as a molded product, however, there have been reports of a plating layer stripping problem actually occurring due to insufficient rigidity and low adhesion with the plating layer.

In view of the above, a composition based on polyamide 6 (PA6) has been developed in order to reinforce rigidity, however, hydrofluoric acid needs to be used during the plating when PA6 is used, which causes another problem due to high safety hazards, therefore, this cannot be considered as a fundamental solution.

Accordingly, needs for a new composite resin composition capable of manufacturing a molded product having sufficient rigidity thereby having small deformation, and having high adhesion with a plating layer have been grown more and more.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspect, the present invention provides a composite resin and composition thereof to provide substantially improved rigidity and plating adhesion.

In addition, the present invention provides a novel material for plating by providing a molded product using the composite resin composition as described herein.

However, an object of the present invention is not limited to the object described above, and other object of the present invention not described above may be clearly understood by those skilled in the art from the descriptions below.

In one aspect, the present invention provides a composite resin and the composition. The composite resin may include a base material such as polyamide resin, an impact modifier, and an inorganic filler. In particular embodiments, the polyamide resin may be, but not limited to, polyphthalamide (PPA).

In an exemplary embodiment, the composite resin may include: polyphthalamide (PPA) in an amount of about 40 to 60% by weight, an impact modifier in an amount of about 10 to 20% by weight and an inorganic filler in an amount of about 20 to 40% by weight, based on the total weight of the composite resin.

The impact modifier may be ethylene-octene rubber (EOR), or alternatively, maleic anhydride grafted ethylene-octene rubber.

In addition, the inorganic filler may be a kaolin-based inorganic filler, a CaCO₃ or calcium silicate-based inorganic filler.

Particularly, in the composite resin, the impact modifier may be oxidized and form an engraved structure on a surface of the composite resin, and the inorganic filler may form an embossed structure on the surface of the composite resin.

The composite resin may further include: a thermal stabilizer; and a lubricant.

In another aspect, the present invention provides a molded product using the composite resin having the above described composition. Further, provided is a plated product that comprises the molded produced using the composite resin.

Still further, the present invention provides a method of manufacturing a plated product. The method may include: preparing a composite resin that comprises polyphthalamide (PPA), an impact modifier and an inorganic filler; oxidizing the impact modifier; and plating the composite resin.

In particular, the impact modifier forms an engraved structure on a surface of the composite resin and the inorganic modifier forms an embossed structure on a surface of the composite resin.

The plating may be chrome plating, but examples thereof may not be limited thereto.

The composite resin may include: the polyphthalamide in 40 to 60% by weight, the impact modifier in 10 to 20% by weight, and the inorganic filler in 20 to 40% by weight, based on the total weigh of the composite resin.

The impact modifier may be ethylene-octene rubber (EOR), or alternatively, maleic anhydride grafted ethylene-octene rubber.

In addition, the inorganic filler may be a kaolin-based inorganic filler, a CaCO₃ or calcium silicate-based inorganic filler.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows an exemplary composite resin according to an exemplary embodiment of the present invention;

FIG. 2 is a table showing compositions and the contents of Example 1 to Example 11 and Comparative Example of the present invention, and results of Measurement Example 1; and

FIG. 3 illustrates an exemplary door handle manufactured according to Examples and Comparative Example of the present invention.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In an exemplary embodiment of the present invention, a composite resin may include a polyphthalamide (hereinafter, ‘PPA’) as a polyamide resin, an impact modifier and an inorganic filler.

Hereinafter, each component will be described in more detail.

(A) Polyphthalamide (PPA)

The PPA may be used as a polyamide series base material having a benzene ring in a polymer chain.

The PPA has both an aromatic group and an aliphatic group on the main chain.

In the present invention, the PPA may be prepared and used by binding an aromatic group and an aliphatic group, or commercially available PPA may be used.

In the composite resin of the present invention, the content of the PPA may range from about 40 to about 60% by weight based on the total weight of the composite resin.

When the content of the PPA is in a range of 40 to 60% by weight, the composite resin may secure mechanical rigidity, and an impact modifier and an inorganic filler to be described later may be sufficiently forming an embossed structure and an engraved structure on the surface of the composite resin, thereby improving plating adhesion.

(B) Impact Modifier

The impact modifier may be used to increase the durability, resistance or strength of a molded product such as molded plastics, under normal condition or stressed condition, e.g. mechanical stress, heat or cold temperature. Further, the impact modifier, as used herein, may provide surficial properties by forming a structure, e.g. an engraved structure on the surface of the composite resin. Examples of the impact modifier may include ethylene-octene rubber.

In particular, maleic anhydride may be grafted on the main chain of the ethylene-octene rubber, such that the maleic anhydride grafted ethylene-octene rubber may also be used considering compatibility and binding properties with the PPA.

Further, ethylene-propylene rubber (EPR), isoprene rubber, a terpolymer of ethylene-propylene-diene (EPDM), ethylene-methacrylic acid (EMAA), styrene-butadiene rubber (SBR) and the like may also be used as the impact modifier.

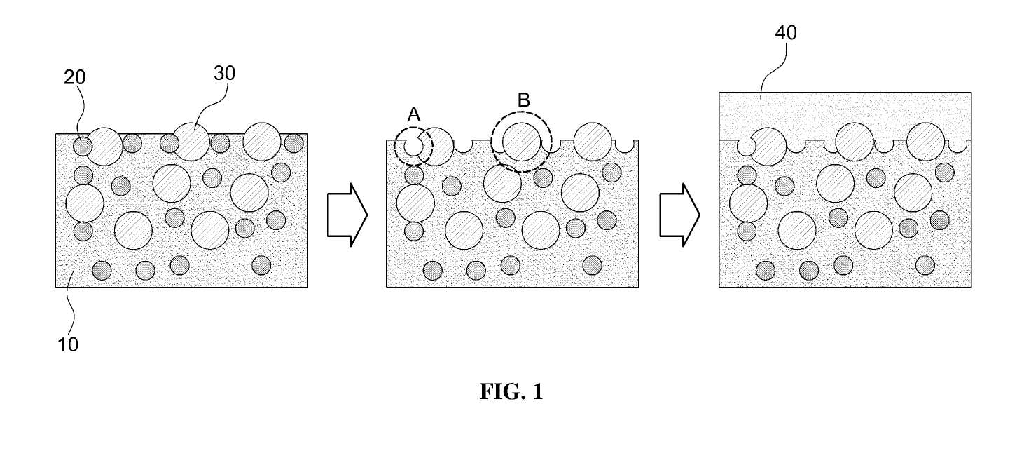

Further, the impact modifier may be in a form of particles, which may have a diameter ranges from about 1.0 μm to about 1.5 μm. As shown in FIG. 1, the impact modifier 20 located on the surface of the composite resin may be oxidized and form an engraved structure A. A method for oxidizing an impact modifier is not specifically limited. However, preferably, the impact modifier of the present invention may be oxidized using mixed liquid of a chromic acid/sulfuric acid.

Accordingly, when the composite resin is plated, a portion of a plating layer 40 may penetrate into an anchor hole by the engraved structure A, and adhesion between the plating layer 40 and the composition may be enhanced.

In the composite resin of the present invention, the content of the impact modifier may range from about 10 to about 20% by weight, based on the total weight of the composite resin.

When the impact modifier is included in less than about 10% by weight, the engraved structure may not be sufficiently obtained, and an embossed structure of an inorganic filler formed by the inorganic filler being pushed to the surface due to the presence of the impact modifier as described later may not be made, and as a result, plating adhesion of the composite resin may be noticeably reduced.

In addition, when the impact modifier is included in greater than about 20% by weight, heat resistance and rigidity may be declined.

(C) Inorganic Filler

The inorganic filler may be used as additives, and particularly, as used herein, may provide surficial properties to the composite resin by forming a structure, e.g. embossed structure, on the surface of the composite resin.

Examples of the inorganic filler used in the present invention may include a kaolin-based inorganic filler as represented in the following Chemical Formula 1. Further, CaCO₃, Calcium Silicate (CaO₃Si) and the like may also be used as the inorganic filler.

Further, the inorganic filler may be in a form of particles, which may have a diameter ranges from about 1.5 μm to about 2.0 μm.

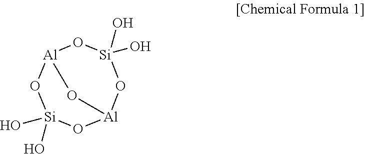

As shown in FIG. 1, the inorganic filler 30 may be located on the surface of the composite resin and may form an embossed structure B. Accordingly, even when external power is repeatedly applied on a plated molded product, a plating layer 40 may be supported on the inorganic filler 30 having an embossed structure B together with the engraved structure A, and thus, stripping of the plating layer 40 may be prevented.

In the composite resin of the present invention, the content of the inorganic filler may range from about 20 to about 40% by weight.

When the content of the inorganic filler is in a range of about 20 to 40% by weight, the embossed structure may be formed without deteriorating the surface appearance of the composition while supporting the plating layer, as consequence, plating adhesion may be enhanced.

When referring to FIG. 1, in preparing a molded product using the composite resin according to the present invention, an engraved structure A by the impact modifier 20 and an embossed structure B by the inorganic filler 30 may be suitably formed on the surface, and stripping of the plating layer 40 may be prevented when the molded product is plated. Moreover, deformation may not occur substantially even when external force is repetitively repeated since PPA 10 may provide suitable strength as a base polymer, and stripping may be prevented since cracks do not occur on the plating layer 40.

### EXAMPLES

Hereinafter, specific examples of the present invention are provided. However, the examples described below are for illustrative or descriptive purposes only, and the present invention is not limited thereto.

### Example and Comparative Example

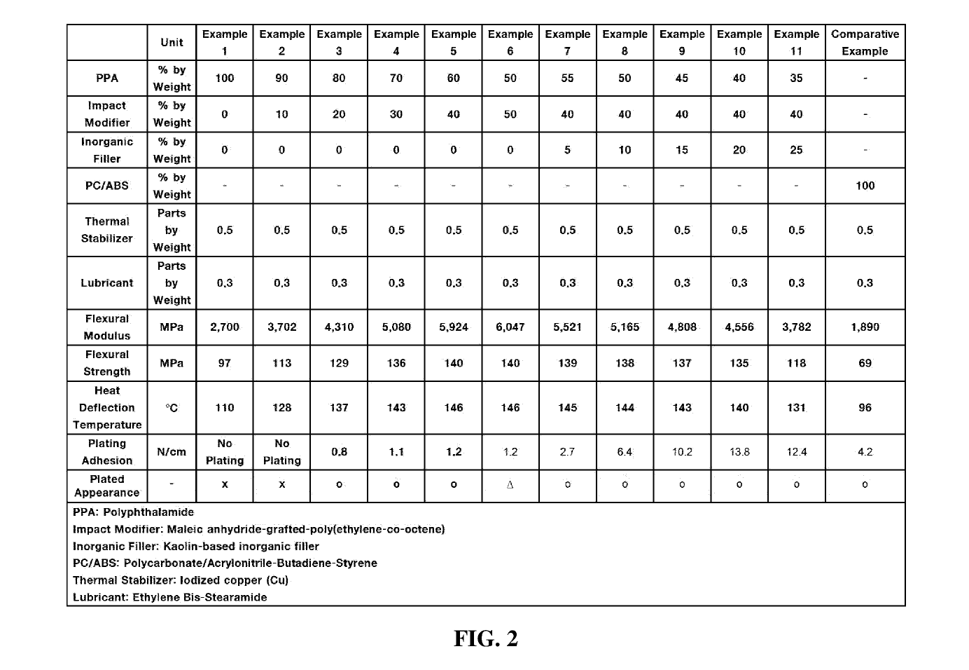

The content of each constituent used in the following examples and the comparative example is as shown in FIG. 2.

Example 1 to Example 6 were prepared with the composite resin compositions by varying the content of an inorganic filler from about 0 to about 50% by weight based on the total weight of the composite resin, and Example 7 to Example 11 were prepared with the composite resin compositions by varying the content of an impact modifier from about 5 to about 25% by weight based on the total weight of the composite resin.

In the comparative example, a composite resin composition having 100% by weight of PC/ABS was prepared.

A thermal stabilizer and a lubricant were added in 0.5 parts by weight and 0.3 parts by weight, respectively, based on 100 parts by weight of the composite resin composition.

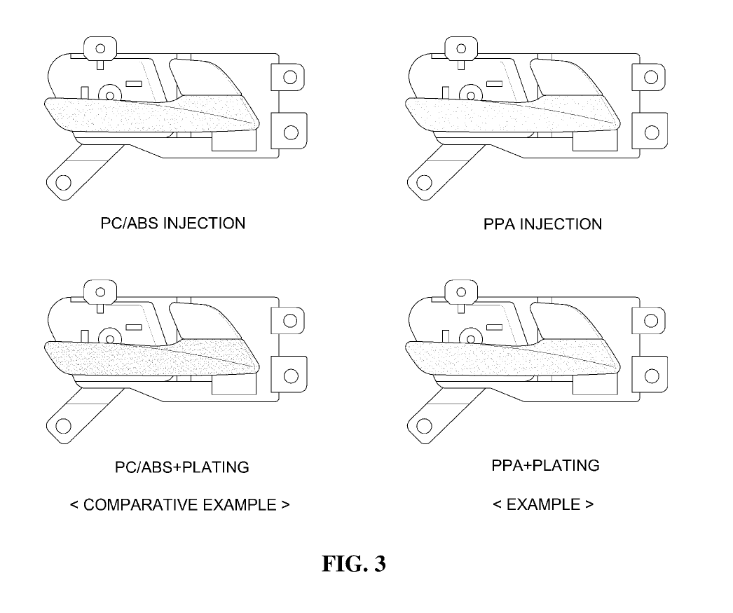

A molded product was made by molding the composite resin composition prepared in the Examples and the Comparative Example as above, and an interior side door handle of a vehicle as shown in FIG. 3 was manufactured by plating (e.g. chrome plating) the molded product.

### Measurement Example 1

Flexural modulus, flexural strength, a heat deflection temperature and plating adhesion of the door handle manufactured in the examples and the comparative example were measured, and a plated appearance was evaluated.

The flexural modulus and the flexural strength were measured using a method of ASTM D790, and the heat deflection temperature was measured using a method of ASTM D648 (1.82 MPa).

The plating adhesion was measured according to ASTM B533, and the method employed a test speed of 50 mm/min, a width of 10 mm, and a measurement length of 50 mm or greater.

The plated appearance was evaluated as favorable (O) when there were dots having a diameter of 0.5 mm or less, and one or less defect having a length of 2.0 mm or less on the plated effective surface.

The results of Measurement Example 1 are as shown in FIG. 2.

When referring to Example 1 to Example 6, the flexural modulus, the flexural strength and the heat deflection temperature of the molded product were rapidly enhanced as the content of the inorganic filler were increased from 0% to 40% by weight.

However, the plating adhesion and the plated appearance evaluation were measured to be the highest when the content of the included inorganic filler was from about 20% to about 40% by weight, as such, the inorganic filler in the above content range is most preferable.

When referring to Example 7 to Example 11, the flexural modulus, the flexural strength, the heat deflection temperature and the plating adhesion were measured to be the highest when the impact modifier was included in about 10% to 20% by weight, therefore, it can be seen that including the impact modifier in the above content range is most preferable.

Example 10 was most suitable as a composite resin composition according to an exemplary embodiment of the present invention since the composition had substantially improved plating adhesion while having sufficient rigidity, and the flexural modulus was enhanced by about 2.5 times, the flexural strength by about 2 times and the plating adhesion by about 3 times or greater compared to the comparative example. Thus, an advantageous effect of the composite resin composition according to the present invention may be identified from Measurement Example 1.

### Measurement Example 2

An evaluation on the performance of the door handle manufactured in Example 10 and the comparative example was carried out.

Evaluation items and results of Measurement Example 2 are as shown in the following Table 1.

TABLE 1

| | Evaluation | | Comparative |
|---|---|---|---|
| Evaluation Item | Method | Example 10 | Example |
| Overload Test | Loading | 85 kgf | 32 kgf |
| Maximum Deformation at | — | 5.03 mm | 12.13 mm |
| End When Loading | | | |
| Opening and Closing | Repeat 100,000 | Satisfactory | Satisfactory |
| Durability | Times | | |
| Heat Resistance Test | Heating for 22 | OK | OK |
| | hours at 90° C. | | |
| Cold Resistance Test | Operation Status at | OK | OK |
| | −40° C. | | |

An overload test was carried out by applying great strength on a door handle and evaluating the degree of the load that the door handle endures, and it was evaluated to be commercializable when the load is about 30 kgf or greater.

Maximum deformation was, when a load of 30 kgf is applied on the door handle, measuring the degree of door handle end bending or moving by the load.

When referring to the evaluations on the overload test and the maximum deformation, it can be identified that Example 10 had greater rigidity than the comparative example, and by using the composite resin composition according to an exemplary embodiment of the present invention, cracks on the plating layer due to excessive deformation and stripping of the plating layer occurring therefrom may be prevented.

### Measurement Example 3

An evaluation on the plating reliability of the door handle prepared in Example10 and the comparative example was carried out.

Evaluation items and results of Measurement Example 3 are as shown in the following Table 2.

TABLE 2

| | | Example | Comparative |
|---|---|---|---|
| Evaluation Item | Evaluation Criteria | 10 | Example |
| Plated | Dots having diameter | No | No Defects |
| Appearance | of 0.5 mm or less, | Defects | |
| | and one or less defect | | |
| | having length of | | |
| | 2.0 mm or less on | | |
| | effective surface | | |
| Plating | 3 N/cm or greater | 13.8 | 4.2 |
| Adhesion | | | |
| Thermal Shock | No surface changes, | OK | OK |
| Test | cracks and swelling | | |
| | after 4 cycles of | | |
| | −40° C. <-> 90° C. | | |
| Cold and Heat | No surface changes, | OK | OK |
| Repeatability | cracks and swelling | | |
| | after carrying out | | |
| | CASS for 8 hours | | |
| Corrosion | Corrosion area ratio | OK | OK |
| Resistance | 0.1% or less, RN9 | | |
| | or less | | |

Example 10 prominently satisfied all the items of the plating reliability evaluation, and plating adhesion was measured to be about 3 times or greater than the comparative example.

The composite resin composition of the present invention has substantially improved rigidity and thereby has small deformation despite repetitive operations, and has substantially improved plating adhesion. As such, when an exemplary composite resin composition is used as a plated molded product, stripping of a plating layer may be prevented and products of improved quality may be provided.

The invention has been described in detail with reference to various exemplary embodiments thereof. However, the present invention is not limited to the examples and may be prepared in various different forms, and it will be appreciated by those skilled in the art that changes may be made in these embodiments without departing from the principles and spirit of the invention. Accordingly, it is to be understood that the examples described above are illustrative in all aspects and are not limitative.

What is claimed is:

1. A composite resin, comprising:
polyphthalamide (PPA);
an impact modifier; and
an inorganic filler:

2. The composite resin of claim 1, wherein the impact modifier is ethylene-octene rubber (EOR).

3. The composite resin of claim 1, wherein the impact modifier is maleic anhydride grafted ethylene-octene rubber.

4. The composite resin of claim 1, wherein the inorganic filler is a kaolin-based inorganic filler, a CaCO₃ or calcium silicate-based inorganic filler.

5. The composite resin of claim 1, comprising the polyphthalamide in 40 to 60% by weight, the impact modifier in 10 to 20% by weight, and the inorganic filler in 20 to 40% by weight, based on the total weigh of the composite resin.

6. The composite resin of claim 1, wherein the impact modifier is oxidized and forms an engraved structure on a surface of the composite resin, and the inorganic filler forms an embossed structure on the surface of the composite resin.

7. The composite resin of claim 1, further comprising:
a thermal stabilizer; and
a lubricant.

8. A molded product manufactured using a composite resin of claim 1.

9. A plated product plating the molded product of claim 8.

10. A method of manufacturing a plated product, comprising:
preparing a composite resin that comprises polyphthalamide (PPA), an impact modifier and an inorganic filler, oxidizing the impact modifier;
plating the composite resin;
wherein at least a portion of the impact modifier and inorganic filler are located on a surface of the composite resin.

11. The method of claim 10, wherein the impact modifier forms an engraved structure on the surface of the composite resin and the inorganic modifier forms an embossed structure on the surface of the composite resin.

12. The method of claim 10, wherein the plating is chrome plating.

13. The method of claim 10, wherein the composite resin comprises the polyphthalamide in 40 to 60% by weight, the impact modifier in 10 to 20% by weight, and the inorganic filler in 20 to 40% by weight, based on the total weigh of the composite resin composition.

14. The method of claim 10, wherein impact modifier is ethylene-octene rubber (EOR), or maleic anhydride grafted ethylene-octene rubber.

15. The method of claim 10, wherein the inorganic filler is a kaolin-based inorganic filler, a CaCO₃ or calcium silicate-based inorganic filler.

16. The method of claim 10, wherein the composite resin further comprises a thermal stabilizer; and a lubricant.
